(19) United States
(12) Patent Application Publication
(10) Pub. No.: US 2025/0341613 A1
(43) Pub. Date: Nov. 6, 2025

(54) OPTICAL RANGING MODULE, METHOD OF ASSEMBLING AN OPTICAL RANGING MODULE, AND METHOD OF MANUFACTURING AN OPTICAL LENS OF AN OPTICAL RANGING MODULE

(71) Applicant: Newmax Technology Co., Ltd., Taichung City (TW)

(72) Inventors: Yung-Fu LIANG, Taichung City (TW); Jiong-Hong CHEN, Taichung City (TW); Kuo-Yuan WU, Taichung City (TW)

(21) Appl. No.: 18/763,938

(22) Filed: Jul. 3, 2024

(30) Foreign Application Priority Data
May 1, 2024 (TW) 113116281

(51) Int. Cl. G01S 7/481; B29D 11/00; G01S 7/4865

(52) U.S. Cl. CPC G01S 7/4813; B29D 11/0048; G01S 7/4865

(57) ABSTRACT

An optical ranging module includes: a base; a light transmitting unit including a first optical lens and an infrared light source, wherein the infrared light source is disposed on the base; a light receiving unit including a second optical lens and a photosensitive element, wherein the photosensitive element is disposed on the base; and a light shielding cap disposed on the base, wherein first and second accommodation spaces are defined between the light shielding cap and the base for respectively accommodating the light transmitting unit and the light receiving unit, and the light shielding cap includes first and second opening areas for respectively disposing the first and second optical lenses; wherein the first and second optical lenses have an integrally formed structure.

This application claims the benefit of Taiwan Patent Application No. 113116281, filed on May 1, 2024, which is hereby incorporated by reference for all purposes as if fully set forth herein.

### BACKGROUND

### Technical Field

The present disclosure relates to an optical ranging module, a method of assembling an optical ranging module and a method of manufacturing an optical lens of an optical ranging module, and in particular to an optical ranging module including first and second optical lenses having an integrally formed structure.

### Related Art

Today's smart phones, tablets or other handheld devices are equipped with TOF (Time of Flight) ranging modules to achieve various functions such as gesture detecting function, three-dimensional (3D) imaging function, or camera focusing function. During operation, the TOF ranging module transmits near-infrared light into an object in the scene and uses the time-of-flight information of the light to measure the distance of the object in the scene. The advantages of the TOF ranging module are small calculation of the depth information, strong anti-interference, and long measurement range, so the TOF ranging module has gradually become popular.

FIG. 1 is a sectional schematic view of a TOF ranging module in the prior art. The TOF ranging module 9 usually includes two optical lenses 91, 92. One is a light emission (TX) optical lens 91. When receiving the light from the infrared light source 93, the unique microstructure is used to shape the light shape, and then the light continues to be transmitted to an object to be measured. The other is the light receiving (RX) optical lens 92, which is used to receive the light reflected from the object. The light returned is then transmitted to the photosensitive element 94. The overall light process is the infrared light source 93→the TX optical lens 91→the object→the RX optical lens 92→the photosensitive element 94.

The TX optical lens 91 and the RX optical lens 92 need to be designed in a matching manner. Using the Field of View (FOV) as an example, the designs of the two optical lenses need to be consistent so that the angles of the emitted light and the received light are the same. For example, the alignment accuracy of the TX optical lens 91 and the RX optical lens 92 also needs to be controlled in order to receive all the complete information of the light. Manufacturing errors of the TX optical lens 91 and the RX optical lens 92 and assembly errors on the light shielding cap 95 may cause the light information loss and the light information bias, affecting the information interpretation of the photosensitive element. For example, the horizontal distance between the TX optical lens 91 and the RX optical lens 92 is 4.00 mm, and the vertical distance is 0.00 mm. However, in the actual manufacturing process, the outline dimensions of the TX optical lens 91 and the RX optical lens 92 will have their own manufacturing errors, and coupled with subsequent assembly errors, the precision of an actual alignment of the TX optical lens 91 and the RX optical lens 92 will be difficult to control.

Furthermore, TX optical lenses and RX optical lenses usually use the same material. First, the TX optical lenses and the RX optical lenses are designed separately; second, mold cores are manufactured separately; third, the TX optical lens and the RX optical lens are manufactured separately (for example, using an imprint molding process); finally, the TX optical lens and the RX optical lens are assembled on the light shielding cap. However, the TOF ranging module in the prior art cannot reduce the manufacturing hours and material costs while maintaining (or even improving) the lens performance.

Thus, an optical ranging module needs to be provided for solving previous problems.

### SUMMARY

An objective of the present disclosure is to provide an optical ranging module including a first optical lens (TX optical lens) and a second optical lens (RX optical lens) having the integrally formed structure, whereby the alignment accuracy of the first optical lens and the second optical lens can be improved.

To achieve the above objective, the present disclosure provides an optical ranging module comprising: a base; a light transmitting unit including a first optical lens and an infrared light source, wherein the infrared light source is disposed on the base; a light receiving unit including a second optical lens and a photosensitive element, wherein the photosensitive element is disposed on the base; and a light shielding cap disposed on the base, wherein first and second accommodation spaces are defined between the light shielding cap and the base for respectively accommodating the light transmitting unit and the light receiving unit, wherein the light shielding cap includes first and second opening regions for respectively disposing the first and second optical lenses; wherein the first and second optical lenses have an integrally formed structure.

The present disclosure further provides a method of assembling an optical ranging module comprising steps of: providing a base; disposing an infrared light source of a light transmitting unit and a photosensitive element of a light receiving unit on the base; disposing a light shielding cap on the base, wherein the light shielding cap includes first and second opening regions; and respectively disposing a first optical lens of the light transmitting unit and a second optical lens of the light receiving unit in the first and second opening regions, wherein the first and second optical lenses have an integrally formed structure, and first and second accommodation spaces are defined between the light shielding cap and the base for respectively accommodating the light transmitting unit and the light receiving unit.

The present disclosure further provides a method of manufacturing an optical lens of an optical ranging module comprising steps of: manufacturing a single mold core; measuring the single mold core; disposing the single mold core in a molding machine; and using the single mold core to make at least one lens material into a semi-finished product of first and second optical lenses having an integrally formed structure.

According to the optical ranging module of the present disclosure, since the first optical lens (TX optical lens) and the second optical lens (RX optical lens) have the integrally formed structure, the alignment accuracy of the first optical lens and the second optical lens can be improved, so as to easily receive all the complete information of the light. Using the field of view (FOV) as an example, the designs of the two optical lenses are consistent, so that the angles of the emitted light and the received light are the same. Furthermore, the present disclosure can reduce the manufacturing error of the first and second optical lenses and the assembly error on the light shielding cap, thereby avoiding the light information loss and the light information bias, and avoiding affecting the information interpretation of the photosensitive element.

### BRIEF DESCRIPTION OF THE DRAWINGS

FIG. 1 is a sectional schematic view of a TOF ranging module in the prior art.

FIG. 2a is a perspective schematic view of an optical ranging module according to the first embodiment of the present disclosure.

FIG. 2b is a sectional schematic view of an optical ranging module according to the first embodiment of the present disclosure.

FIG. 3a is a flow chart of a method of manufacturing an optical lens of an optical ranging module according to an embodiment of the present disclosure.

FIG. 3b is a flow chart of a method of manufacturing an optical lens of an optical ranging module according to another embodiment of the present disclosure.

FIG. 4 is a sectional schematic view of a method of assembling an optical ranging module according to an embodiment of the present disclosure.

FIG. 5a is a perspective schematic view of an optical ranging module according to the second embodiment of the present disclosure.

FIG. 5b is a sectional schematic view of an optical ranging module according to the second embodiment of the present disclosure.

FIG. 6a is a perspective schematic view of an optical ranging module according to the third embodiment of the present disclosure.

FIG. 6b is a sectional schematic view of an optical ranging module according to the third embodiment of the present disclosure.

FIG. 7a is a perspective schematic view of an optical ranging module according to the fourth embodiment of the present disclosure.

FIG. 7b is a sectional schematic view of an optical ranging module according to the fourth embodiment of the present disclosure.

FIG. 8a is a perspective schematic view of an optical ranging module according to the fifth embodiment of the present disclosure.

FIG. 8b is a sectional schematic view of an optical ranging module according to the fifth embodiment of the present disclosure.

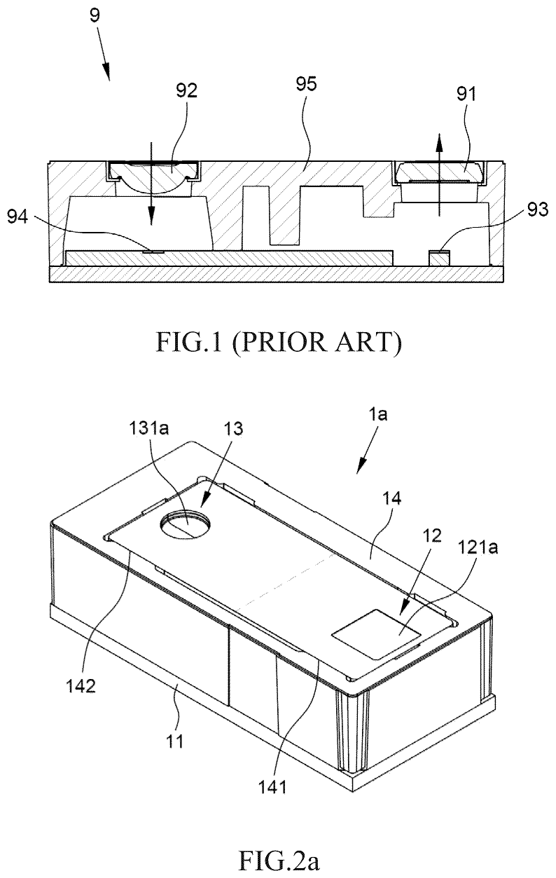

### DETAILED DESCRIPTION

To make the foregoing objectives, characteristics and features of the present disclosure more comprehensible, preferred embodiments of the present disclosure are described in detail below with reference to the accompanying drawings.

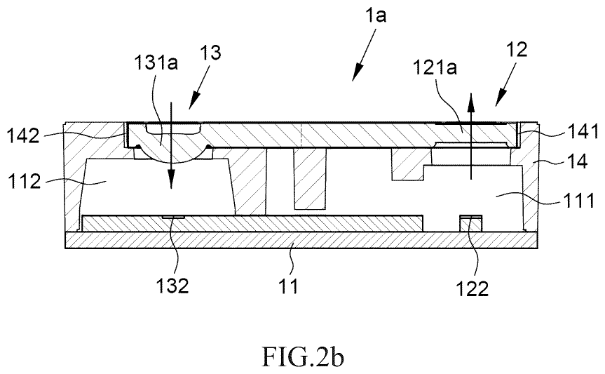

FIG. 2a is a perspective schematic view of an optical ranging module according to the first embodiment of the present disclosure. FIG. 2b is a sectional schematic view of an optical ranging module according to the first embodiment of the present disclosure. Referring to FIG. 2a and FIG. 2b, the optical ranging module 1a includes: a base 11, a light transmitting unit (TX unit) 12, a light receiving unit (RX unit) 13 and a light shielding cap 14. The light transmitting unit 12 includes a first optical lens (TX optical lens) 121a and an infrared light source 122, wherein the infrared light source 122 is disposed on the base 11. The light receiving unit 13 includes a second optical lens (RX optical lens) 131a and a photosensitive element 132, wherein the photosensitive element 132 is disposed on the base 11. The light shielding cap 14 is disposed on the base 11, wherein first and second accommodation spaces 111, 112 are defined between the light shielding cap 14 and the base 11 for respectively accommodating the light transmitting unit 12 and the light receiving unit 13, wherein the light shielding cap 14 includes first and second opening regions 141, 142 for respectively disposing the first and second optical lenses 121a, 131a. In the first embodiment, the first and second optical lenses 121a, 131a can be made of the same material.

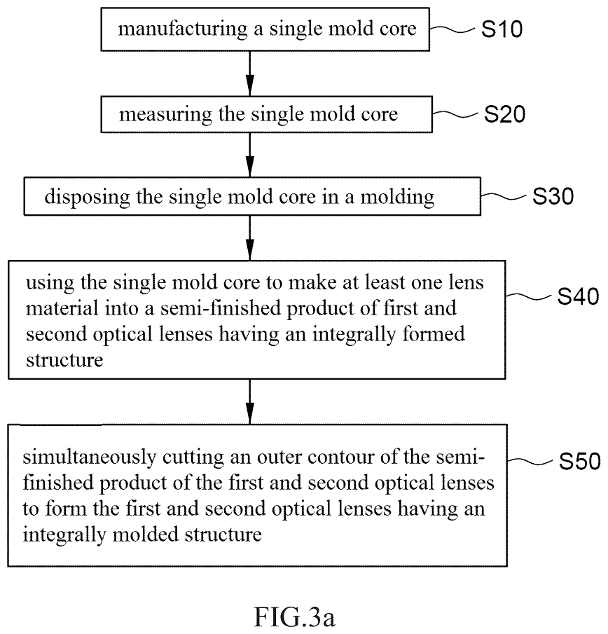

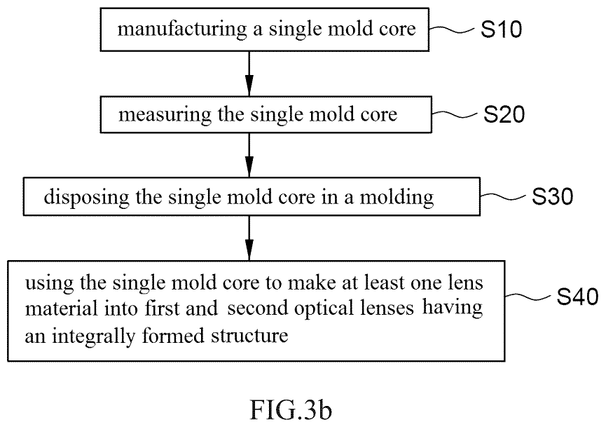

FIG. 3a is a flow chart of a method of manufacturing an optical lens of an optical ranging module according to an embodiment of the present disclosure. The method of manufacturing an optical lens of an optical ranging module includes: in step S10, manufacturing a single mold core; in step S20, measuring the single mold core; in step S30, disposing the single mold core in a molding machine (such as an impression molding machine); in step S40, using the single mold core (such as using an impression molding process) to make at least one lens material (such as resin, plastic, glass, and other raw materials, etc.) into a semi-finished product of first and second optical lenses having an integrally formed structure, whereby the raw material can be removed in the material tube of the molding machine at one time to save the raw material; and, in step S50, simultaneously cutting an outer contour of the semi-finished product of the first and second optical lenses to form the first and second optical lenses having an integrally molded structure, thereby reducing the instability of the outer contour of the semi-finished product of the first and second optical lenses. Alternatively, FIG. 3b is a flow chart of a method of manufacturing an optical lens of an optical ranging module according to another embodiment of the present disclosure. The method of manufacturing an optical lens of an optical ranging module includes: in step S10, manufacturing a single mold core; in step S20, measuring the single mold core; in step S30, disposing the single mold core in a molding machine (such as an injection molding machine); and, in step S40, using the single mold core (such as using an injection molding process) to manufacture at least one lens material (such as resin, plastic, glass, and other raw materials, etc.) into a semi-finished product of first and second optical lenses having an integrally formed structure, whereby the raw material can be removed in the material tube of the molding machine at one time to save the raw material. For example, the optical lens of the present disclosure can be manufactured by using SABIC's EXTEM XH1015/XH1015UCL resin, which is an amorphous thermoplastic polyimide (TPI) resin.

The method of manufacturing the optical lens of the present disclosure can reduce the raw materials and the manufacturing cost of the mold core, and reduce the working hours of manual loading and unloading of molds, manual material placement, assembly of molding machines, etc., and improve the manufacturing efficiency of the optical ranging module of the present disclosure.

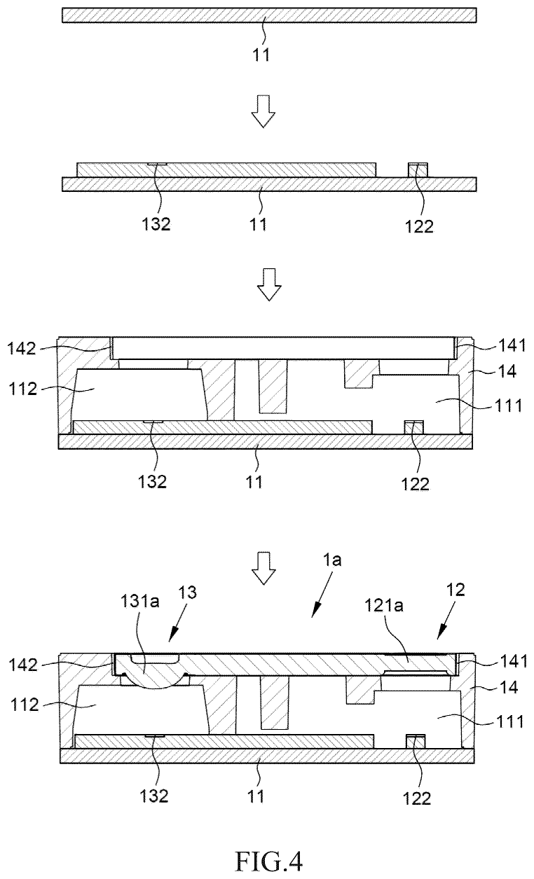

FIG. 4 is a sectional schematic view of a method of assembling an optical ranging module according to an embodiment of the present disclosure. The method of assembling an optical ranging module includes: providing a base 11; disposing an infrared light source 122 of a light transmitting unit 12 and a photosensitive element 132 of a light receiving unit 13 on the base 11; disposing a light shielding cap 14 on the base 11, wherein the light shielding cap 14 includes first and second opening regions 141, 142; and, respectively disposing a first optical lens 121a of the light transmitting unit 12 and a second optical lens 131a of the light receiving unit 13 in the first and second opening regions 141, 142, wherein the first and second optical lenses 121a and 131a have an integrally formed structure, and first and second accommodation spaces are defined between the light shielding cap 14 and the base 11 for respectively accommodating the light transmitting unit 12 and the light receiving unit 13.

For example, the optical ranging module 1a of the present disclosure can be a TOF ranging module, and includes: the infrared light source 122, such as an infrared vertical cavity surface emitting laser (VCSEL); the photosensitive element 132, such as light sensors or Single Photon Avalanche Diode (SPAD); and the time to digital converter (TDC). SPAD is a photodetection avalanche diode with single-photon detection capability, which can generate current as long as there is a weak light signal. The VCSEL emits infrared pulse light to an object to be measured in the scene, the SPAD receives the infrared pulse light reflected from the object, and the TDC records the time interval between the emitted light and the received light (that is, the flight time), and uses the flight time to calculate the distance of the object. Therefore, the accuracy of the time interval between the emitted light and the received light is directly related to the accuracy of the distance of the object. In other words, it is necessary to determine the time when the VCSEL emits infrared pulse light, and the time when the SPAD receives the infrared pulse light reflected from the object. The overall light process is the VCSEL light source→the first optical lens (TX optical lens)→the object→the second optical lens (RX optical lens)→the SPAD light sensor.

According to the optical ranging module of the present disclosure, since the first optical lens (TX optical lens) and the second optical lens (RX optical lens) have the integrally formed structure, the alignment accuracy of the first optical lens and the second optical lens can be improved, so as to easily receive all the complete information of the light. Using the field of view (FOV) as an example, the designs of the two optical lenses are consistent, so that the angles of emitted light and received light are the same. Furthermore, the present disclosure can reduce the manufacturing error of the first and second optical lenses and the assembly error on the light shielding cap, thereby avoiding the light information loss and the light information bias, and avoiding affecting the information interpretation of the photosensitive element.

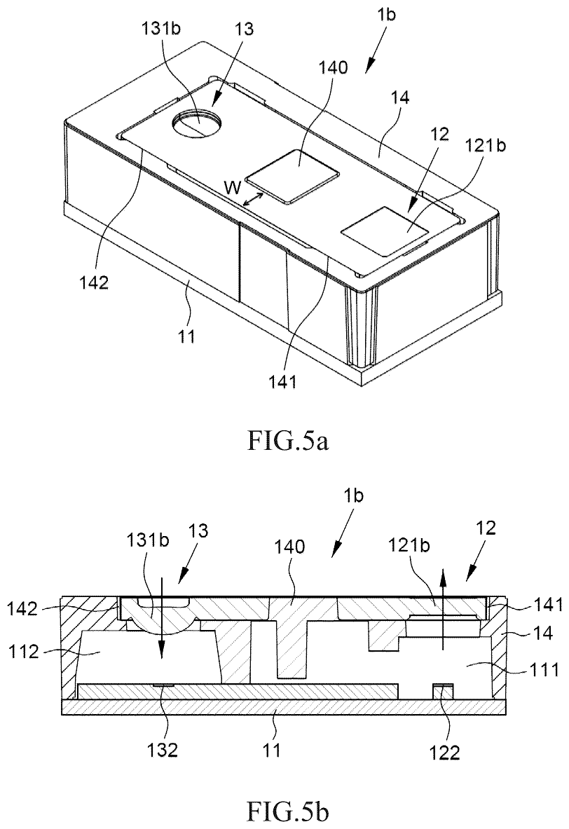

FIG. 5a is a perspective schematic view of an optical ranging module according to the second embodiment of the present disclosure. FIG. 5b is a sectional schematic view of an optical ranging module according to the second embodiment of the present disclosure. The optical ranging module 1b includes: a base 11, a light transmitting unit 12, a light receiving unit 13 and a light shielding cap 14. The first and second optical lenses 121b, 131b have an integrally formed structure. The optical distance measurement module in the second embodiment is substantially similar to the optical ranging module in the first embodiment, and the same elements are labeled with the same reference numerals. The main difference between the optical ranging modules of the second embodiment and the first embodiment is that the light shielding cap 14 in the second embodiment further includes a positioning pillar 140, which is disposed between the first and second optical lenses 121b, 131b for positioning the first and second optical lenses 121b, 131b. In addition, the first and second optical lenses 121b, 131b surrounding the positioning pillar 140 need to retain a width W that is greater than or equal to the lens thickness (for example, to retain a width W of at least 0.32 mm) to maintain the formability and lens strength.

The positioning pillar of the light shielding cap of the present disclosure can be used as the assemble positioning of the first optical lens (TX optical lens) and the second optical lens (RX optical lens) to improve the alignment accuracy between the first and second optical lenses and the light shielding cap. Furthermore, the positioning pillar with a light-shielding effect can also be used to separate the optical properties of the first and second optical lenses and to prevent the first and second optical lenses from interfering with each other.

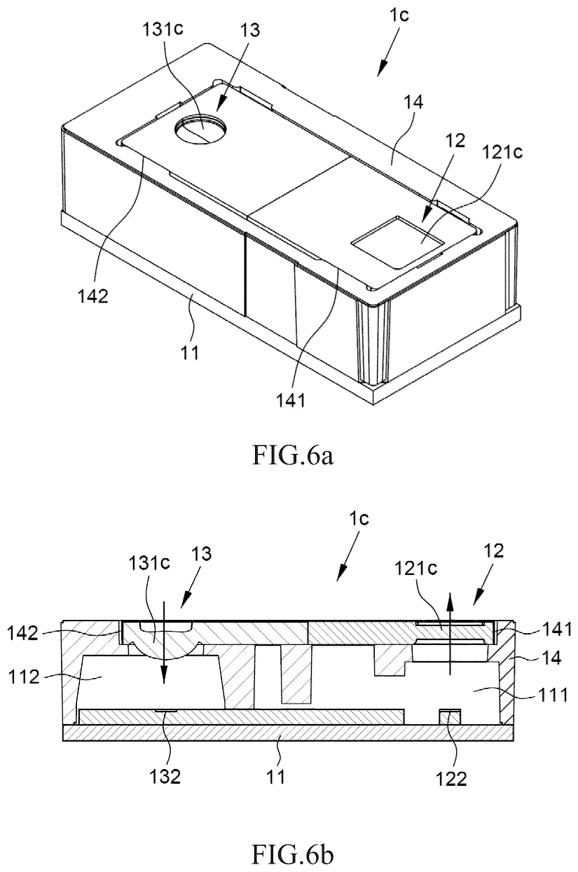

FIG. 6a is a perspective schematic view of an optical ranging module according to the third embodiment of the present disclosure. FIG. 6b is a sectional schematic view of an optical ranging module according to the third embodiment of the present disclosure. The optical ranging module 1c includes: a base 11, a light transmitting unit 12, a light receiving unit 13 and a light shielding cap 14. The optical ranging module in the third embodiment is substantially similar to the optical ranging module of the first embodiment, and the same elements are labeled with the same reference numerals. The main difference between the optical ranging modules in the third embodiment and the first embodiment is that the first and second optical lenses 121c, 131c in the third embodiment are made of different materials. The present disclosure still uses a single mold core of a molding machine (such as an injection molding machine) to form an integrally formed structure of the first and second optical lenses 121c, 131c made of different materials.

Usually, the material selection of the first optical lens (TX optical lens) and the second optical lens (RX optical lens) will be considered to be consistent. For example, the TOF ranging module needs to go through a reflow soldering step in the module manufacture process, so a requirement for the temperature resistance of optical lenses is high; for another example, the TOF ranging module is mainly used for distance measurement, so a requirement for the transmittance of near-infrared light is also high. The first optical lens (TX optical lens) and the second optical lens (RX optical lens) of the present disclosure are made of different materials to achieve specific requirements of the optical performance.

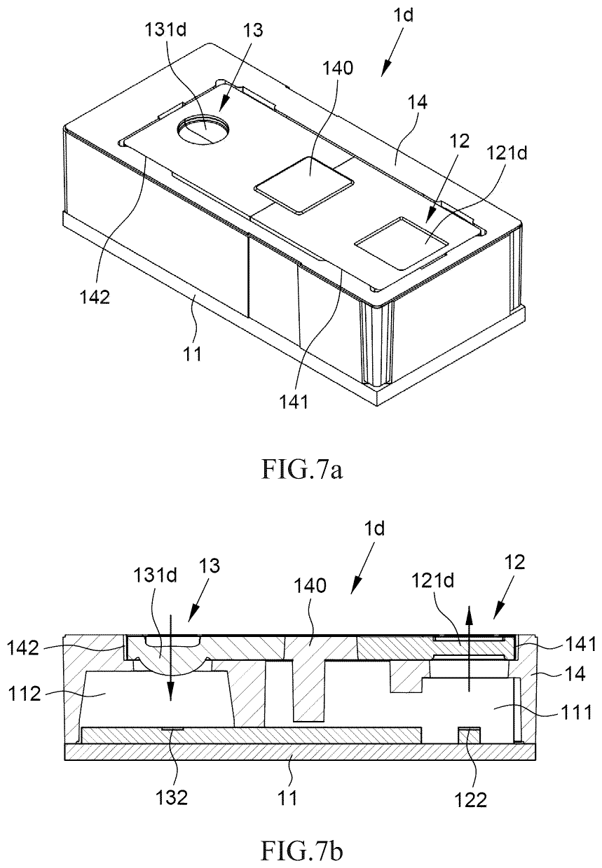

FIG. 7a is a perspective schematic view of an optical ranging module according to the fourth embodiment of the present disclosure. FIG. 7b is a sectional schematic view of an optical ranging module according to the fourth embodiment of the present disclosure. The optical ranging module 1d includes: a base 11, a light transmitting unit 12, a light receiving unit 13 and a light shielding cap 14. The first and second optical lenses 121d, 131d have an integrally formed structure. The optical ranging module of the fourth embodiment is substantially similar to the optical ranging module of the third embodiment, and the same elements are labeled with the same reference numerals. The main difference between the optical ranging modules of the fourth embodiment and the third embodiment is that the light shielding cap 14 of the fourth embodiment further includes a positioning pillar 140, which is disposed between the first and second optical lenses 121d, 131d for positioning the first and second optical lenses 121d, 131d.

The positioning pillar of the light shielding cap of the present disclosure can be used as the assemble positioning of the first optical lens (TX optical lens) and the second optical lens (RX optical lens) to improve the alignment accuracy between the first and second optical lenses and the light shielding cap. Furthermore, the positioning pillar with a light-shielding effect can also be used to separate the optical properties of the first and second optical lenses and to prevent the first and second optical lenses from interfering with each other.

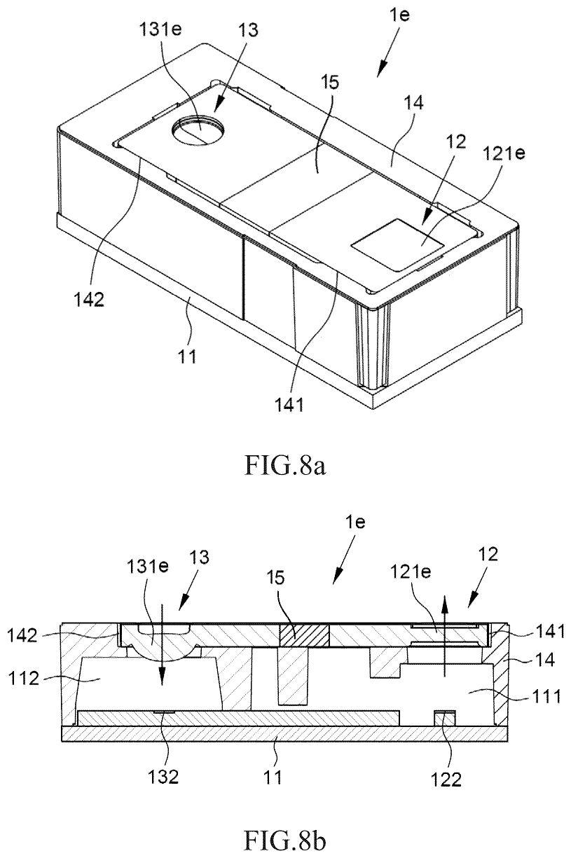

FIG. 8a is a perspective schematic view of an optical ranging module according to the fifth embodiment of the present disclosure. FIG. 8b is a sectional schematic view of an optical ranging module according to the fifth embodiment of the present disclosure. The optical ranging module 1e includes: a base 11, a light transmitting unit 12, a light receiving unit 13 and a light shielding cap 14. The first and second optical lenses 121e, 131e have an integrally formed structure. The optical ranging module of the fifth embodiment is substantially similar to the optical ranging module of the first embodiment, and the same elements are labeled with the same reference numerals. The main difference between the optical ranging module of the fifth embodiment and the first embodiment is that the optical ranging module 1e of the fifth embodiment further includes: a light-shielding material 15 located between the first and second optical lenses 121e, 131e, wherein the light-shielding material 15 and the first and second optical lenses 121e, 131e have an integrally formed structure. In the fifth embodiment, the first and second optical lenses 121e and 131e can be made of the same material. In other embodiments, the first and second optical lenses 121e and 131e can be made of different materials. The present disclosure still uses a single mold core of a molding machine (such as an impression molding machine or an injection molding machine) to form an integrally formed structure of the light-shielding material 15 and the first and second optical lenses 121e, 131e. For example, a method of manufacturing an optical lens of an optical ranging module includes the following steps of: manufacturing a single mold core; measuring the single mold core; disposing the single mold core in a molding machine (such as an impression molding machine); using the single mold core (for example, using an impression molding process) to make at least two lens materials (such as resin, plastic, glass, and other raw materials, etc.) into a semi-finished product of a light-shielding material and first and second optical lenses having an integrally formed structure; and, simultaneously cutting an outer contours of the semi-finished product of the light-shielding material and the first and second optical lens to form the light-shielding material, and the first and second optical lenses having an integrally formed structure. For another example, a method of manufacturing an optical lens of an optical ranging module includes the following steps of: manufacturing a single mold core; measuring the single mold core; disposing the single mold core in a molding machine (such as an injection molding machine); and, using the single mold core (for example, using an injection molding process) at least two lens materials (such as resin, plastic, glass, and other raw materials, etc.) into a light-shielding material, first and second optical lenses having an integrally formed structure.

The light-shielding material of the present disclosure can be used to separate the optical properties of the first optical lens (TX optical lens) and the second optical lens (RX optical lens) and to prevent the first and second optical lenses from interfering with each other.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. An optical ranging module, comprising:
a base;
a light transmitting unit including a first optical lens and an infrared light source, wherein the infrared light source is disposed on the base;
a light receiving unit including a second optical lens and a photosensitive element, wherein the photosensitive element is disposed on the base; and
a light shielding cap disposed on the base, wherein first and second accommodation spaces are defined between the light shielding cap and the base for respectively accommodating the light transmitting unit and the light receiving unit, wherein the light shielding cap includes first and second opening regions for respectively disposing the first and second optical lenses;
wherein the first and second optical lenses have an integrally formed structure.

2. The optical ranging module according to claim 1, wherein the first and second optical lenses are made of the same material or different materials.

3. The optical ranging module according to claim 2, wherein the light shielding cap comprises a positioning pillar disposed between the first and second optical lenses for positioning the first and second optical lenses.

4. The optical ranging module according to claim 2, further comprising: a light shielding material located between the first and second optical lenses, wherein the light shielding material and the first and second optical lenses are an integrally formed structure.

5. The optical ranging module according to claim 3, further comprising: a light shielding material located between the first and second optical lenses, wherein the light shielding material and the first and second optical lenses are an integrally formed structure.

6. A method of assembling an optical ranging module, comprising steps of:
providing a base;
disposing an infrared light source of a light transmitting unit and a photosensitive element of a light receiving unit on the base;
disposing a light shielding cap on the base, wherein the light shielding cap includes first and second opening regions; and
respectively disposing a first optical lens of the light transmitting unit and a second optical lens of the light receiving unit in the first and second opening regions, wherein the first and second optical lenses have an integrally formed structure, and first and second accommodation spaces are defined between the light shielding cap and the base for respectively accommodating the light transmitting unit and the light receiving unit.

7. The method of assembling an optical ranging module according to claim 6, wherein the first and second optical lenses are made of the same material or different materials.

8. The method of assembling an optical ranging module according to claim 6, wherein the light shielding cap comprises a positioning pillar disposed between the first and second optical lenses for positioning the first and second optical lenses.

9. The method of assembling an optical ranging module according to claim 7, wherein the light shielding cap comprises a positioning pillar disposed between the first and second optical lenses for positioning the first and second optical lenses.

10. The method of assembling an optical ranging module according to claim 6, further comprising: a light shielding material located between the first and second optical lenses, wherein the light shielding material and the first and second optical lenses are an integrally formed structure.

11. The method of assembling an optical ranging module according to claim 7, further comprising: a light shielding material located between the first and second optical lenses, wherein the light shielding material and the first and second optical lenses are an integrally formed structure.

12. A method of manufacturing an optical lens of an optical ranging module, comprising steps of:
manufacturing a single mold core;
measuring the single mold core;
disposing the single mold core in a molding machine; and
using the single mold core to make at least one lens material into a semi-finished product of first and second optical lenses having an integrally formed structure.

13. The method of manufacturing an optical lens of an optical ranging module according to claim 12, further comprising steps of: simultaneously cutting an outer contour of the semi-finished product of the first and second optical lenses to form the first and second optical lenses having an integrally molded structure, wherein the first and second optical lenses are made of the same material or different materials.
